(19) United States
(12) Patent Application Publication
(10) Pub. No.: US 2025/0066986 A1
(43) Pub. Date: Feb. 27, 2025

(54) SYSTEM AND EMBODIMENT FOR AN ENERGY-EFFICIENT AND EFFECTIVE CLOTH DRYER

(71) Applicant: Arvin Radan, Port Moody (CA)

(72) Inventor: Arvin Radan, Port Moody (CA)

(73) Assignee: Radinsight Consulting & Trading Co., Port Moody, BC (CA)

(21) Appl. No.: 18/456,463

(22) Filed: Aug. 25, 2023

(51) Int. Cl. D06F 58/10; B01D 53/22; B01D 53/26; D06F 34/05; D06F 34/18; D06F 34/26; D06F 58/12; D06F 58/22; D06F 58/24; D06F 58/26; D06F 58/48; F17C 1/00; H05B 6/68; H05B 6/80

(52) U.S. Cl. CPC D06F 58/10; B01D 53/22; B01D 53/268; D06F 34/05; D06F 34/18; D06F 34/26; D06F 58/12; D06F 58/22; D06F 58/24; D06F 58/266; D06F 58/48; F17C 1/00; H05B 6/681; H05B 6/80; B01D 2053/221; D06F 2103/08; D06F 2103/30; D06F 2103/32; D06F 2105/28; D06F 2105/30; D06F 2105/36; F17C 2203/0631; F17C 2205/0323; F17C 2221/031; F17C 2227/0302; F17C 2270/05; F17C 2270/07; H05B 2206/046

(57) ABSTRACT

The invention discloses a new embodiment concept and components for drying articles in an energy-efficient and effective way. The embodiment has a stationary drum accommodating a grid with several underneath nozzles at the bottom for blowing compressed hot air into articles and moving them within the space. A magnetron generates microwaves inside the drum for evaporating articles' moisture. A reciprocating compressor vacuums out the hot vapor and compresses it again in a high-pressure three-layer multifunctional tank after passing through a set of moisture separators to be reused by the nozzles in a closed cycle. Several low-maintenance and durable Membrane Dryers are used in parallel as a moisture separator unit before the compressor. Condensed and separated liquid is used in a heat exchanger to warm the makeup air needed for membranes. Nozzles' on/off states, the magnetron and compressor are controlled by a closed-loop digital controller for achieving an optimized drying process.

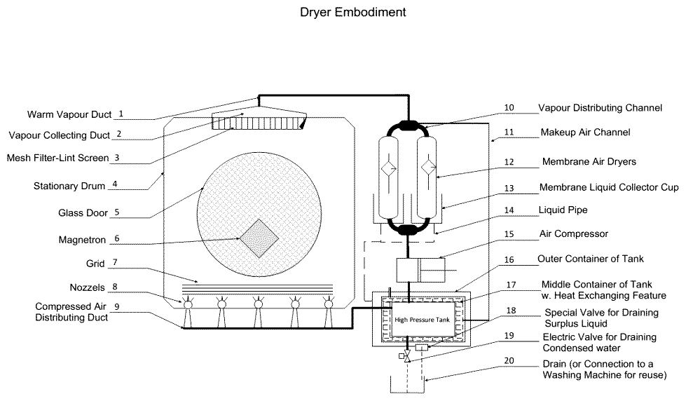

### PRIOR ART

Different approaches have been proposed for providing heating air for dryers in the past inventions. The most conventional methods are gas fired or electric element heaters. Recently heat pumps have been employed to extract ambient heat or exhaust vapor heat. A modern, but still under development, method is extracting moisture from cloth using ultrasound. In the following, the prior art will be investigated individually.

CA 03145256 published in 2021 proposes a continuous heating system using a microwave heating process at the point of production for manufacturing asphalt mix which is a similar application of microwaves.

CA 03050684 published in 2019 discloses a dryer using a high frequency electric field in addition to heated air to dry the articles. The invention claims that using high frequency may solve the problem of a decrease in drying efficiency and residual moisture in cloths for conventional dryers. This solution is associated with more costs and energy consumption.

U.S. Pat. No. 0,142,951 published in 2018 proposes a dryer including piezoelectric oscillation transducers to generate high frequency vibrational mechanical energy for extracting moisture from cloths. The drying occurs when direct contact occurs between an article and one of the mesh layers transducers which may make the drying process tardy or incomplete because some spots of an article may not come in direct contact with transducers. Another problem is the mechanical stress on the materials that can lead to earlier wear-out of clothes.

CN 105972984 published in 2018 discloses a waste heat recycling device for a textile cloth dryer where an exhaust gas pretreatment bin removes the impurities, and the humid and hot waste gas is blast into the cloth for pre-drying. It might improve the energy efficiency of dryers to some extent but is associated with increased costs.

CA 2973708 application filed on 2017 discloses equipment heating wet articles to evaporate their moisture and compressing the vapor into a heat exchanger to increase its temperature. The heat exchanger transfers the thermal energy of exhaust vapor to the articles under drying process. This invention may improve the efficiency of dryer through recovery of exhaust gas heat but adding a compressor to the heat exchanging system is associated with more cost and electricity consumption.

CA 02453625 published in 2003 provides a stationary dryer comprising of a housing with horizontal supports and device for generating air flow and air distribution system that makes the drying process very time-consuming.

CA 2178993 published in 1995 proposes Halogen-Type Light as the source of heat in a conventional dryer without any further improvement. It employs photonic bombardment of articles in a drum to dry them. It is a different technology with doubts about the effectiveness and long duration of drying process.

### BACKGROUND OF THE INVENTION

Electric cloth dryers consume about 4% of total annual residential electricity use and are one of the largest energy consuming appliances in household. Enormous efforts have been taken to advance the technology so that the dryer can offer higher energy factor and shorter drying time. As the life quality of families depends on dryers for daily usage, even a small improvement in energy factor or the drying cycle duration can lead to the vast amount of savings in terms of energy and household time which are very essential in large cities.

Modern dryers employ heat pump technology to transfer ambient heat or exhaust heat to dryer compartments in order to consume less electricity for the drying process. The main and common problem of past inventions is venting the hot vapor out and wasting the heat that can be reused. This invention has overcome this problem through a closed cycle for the warm air extracting moisture from the cloth. The heat pump dryers reusing the exhaust air are limited by the moisture left in the reused air after evaporator. Once the air is warmed up again, its humidity becomes lower but is still enough to prolong the drying process. Another common problem of past inventions is the mechanism of extracting moisture from clothes. Heat is known as a common method to evaporate the moisture but it's not very effective as heat takes time to permeate to the inner layers of cloths. The application of higher temperature to accelerate it is associated with the risk of hotspots for cloths.

Microwaves infiltrate into the inner layer of cloth very fast and evaporate water molecules. If used in an appropriate way, it can be an effective solution to extract and evaporate moisture deeply from the cloth tissues.

This invention can be classified as CPC F26B 3/00, 7/00, 13/08, 21/00, and 23/00, and A47L.

### SUMMARY OF THE INVENTION

This invention relates to an energy efficient and fast cloth drying concept using a closed-loop controlled microwave generator (magnetron) and compressed air to fly cloths inside the dryer compartment. Moisture separators from membrane dryer type are used to separate moisture from hot vapor so that the dried warm air can be reused in the drying process to save more energy. A heat-exchanging mechanism is also employed to harvest the heat energy of separated liquid from vapor to achieve higher efficiency. As there is no need for a rotating drum and electric resistant heater or heat pump, the new concept can improve the efficiency of dryer while keeping it affordable.

### BRIEF DESCRIPTION OF DRAWINGS

The FIGURE illustrates the embodiment of this new concept. This apparatus has no rotating drum or electric element as the source of heat. It circulates the heated air in a closed cycle to reuse its heat.

### DETAILED DESCRIPTION OF THE INVENTION

The provided FIGURE depicts the embodiment of this new concept. It comprises of a compartment which substitutes the conventional rotating drum in a dryer and is called the stationary drum here. It accommodates several air nozzles [8] at its bottom for blowing compressed warm air underneath the cloths on the grid [7] and making cloths fly in the space of stationary drum [4]. The number of nozzles and their placement varies depending on the capacity and the type of cloth dryer. A magnetron [6] generates microwaves at an adjustable power to evaporate the cloth moisture for a fast and efficient drying process. Moisture and temperature sensors (not shown) provide feedback signals for a closed loop controller (not shown) to control the nozzles on/off states and magnetron power for a safe and effective drying process that avoids hotspot on cloths. The glass door [6] of the stationary drum is also protected with a grille to encapsulate microwaves inside the drum for safety.

The dry warm air of nozzles absorbs the residual cloth moisture inside the drum and converts it to vapor. This vapor is vacuumed out through the collecting duct [2] and passes through a removable mesh filter and lint screen [3] at the top of drum to block cloth lint and fluff. The vacuumed hot vapor is conducted through the duct [1] to a distributing system [10] which distributes the vapor among several parallel membrane dryers [12] to separate moisture from air. The number of membranes depends on the type and capacity of dryer. The dried air will be collected again and enters to a reciprocating compressor [15] to increase its pressure in the high-pressure tank. As the air gets compressed, its temperature increases also. The hot and dry pressurized air is supplied to nozzles [8] through the distributing pipe [9] to start a new cycle.

The high-pressure tank is a three-layer container. The inner container is for accumulating hot and dry air under a certain pressure controlled by a closed loop controller (not shown). Middle layer/container [17] has a heat exchanging feature and heat up the make-up air needed for membranes and provided through the pipe [11].

The moisture separated from air in each membrane purges out in a liquid form at the bottom and is collected by a built-in collector cup [13]. This warm water is conducted to the outer container [17] of the high-pressure tank to exchange its heat with both make-up air and pressurized dry air inside the inner tank. The regulator [18] adjusts the warm water level of outer container and conducts the excessive water to drain [20]. This water can be used in a side washing machine if an appropriate mechanism is designed for. A small amount of moisture can remain in the air exiting membrane. This moisture can be liquefied in the high-pressure tank as the pressure increases. Accumulated hot water at the bottom of tank exchanges its heat with the make-up air and is drained by the electric valve [19] at the end of drying process.

In this concept, electrical energy is efficiently used for generating microwaves and pressurizing air in the compressor. The heat generated through compressed air contributes to the drying process and the mechanical energy of pressurized air contributes to the movement of cloths inside the stationary drum.

As the moisture is separated from air in the membranes and the dried air is reused, its heat isn't wasted. Furthermore, the heat energy of separated moisture will be used to warm the make-up air needed by the membranes.

1. A concept and a system embodiment for an energy-efficient and effective drying process that can be used in any applications including cloth dryer. The system's embodiment (FIGURE) which can be sized, and detail designed properly to be used in all residential, commercial, and industrial applications and comprises of:
a) a stationary drum [1] with a grilled glass door [6] to operate the drying process on articles inside it using microwaves generated by a magnetron with an adjustable power, duty cycles, and duty ratio controlled through a digital controller (not shown);
b) a set of nozzles [8] at the bottom of drum to blow hot compressed air underneath the articles laying on a grid [7] and to fly them in the drum space for an effective homogenous drying process. The nozzles' on/off states will be controlled by a digital controller (not shown) receiving feedback from several moisture sensors (not shown) within the drum space;
c) a collecting duct [2] with a removable mesh filter and lint screen [3] at the top of drum to vacuum the vapor inside the drum and block articles' lint and fluff. The vapor is conducted to a drying and compressing process through another duct [1] and will be delivered to a distributing duct [10] for drying stage;
d) a set of membrane dryers [12] working in parallel to receive the vapor and separate its moisture. Membrane dryers purge the moisture in liquid form using pre-heated make-up air received through the channel [10]. The membrane dryers are equipped with a built-in cup [13] to collect the purged liquid to be reused for pre-heating the make-up air;
e) an air compressor [13] to receive the almost dried warm air from membrane output collector and to increase the air pressure for rising its temperature and condensing the remaining humidity. The compressor is controlled by a digital controller (not shown) to create an optimized pressure for the hot and dry air depending on the weight and dryness of articles in the stationary drum. The compressor further creates enough vacuum for the mobility of vapor from drum space to membrane dryers in a closed cycle and for the mobility of membrane pre-heated make-up air;
f) a special three-layer high pressure tank for storing pressurized hot air to be reused by drum nozzles [8] through a distributing channel [9]. The outer layer container [16] of this tank is for storing warm liquid purged from membrane dryers and is connected to their cups through a pipe [14]. A special valve [18] drains the overflow liquid. The middle layer space [17] of this tank is a heat exchanger pre-heating the make-up air of membrane dryers and is connected to them through the air channel [11]. The inner layer container is for storing and pressurizing dried hot air. The condensed liquid built up at the bottom of inner layer container will be drained at the end of drying process through an electric valve [19];
g) a container [20] to collect drained liquids and can be connected to a side washing machine for reusing the liquid or to a sewer system for discharging the liquid.

2. The Concept and embodiment as claimed in claim 1, together forming a modular drying unit which can be arranged in any size and capacity to fit to any drying applications in domestic residential, commercial, institutional, or light industrial sectors for drying any products in an energy-efficient, effective, and sustainable way.

3. The concept and embodiment as claim 1 and 2, further comprising different dryness, temperature, and air pressure sensors and a digital controller for adjusting the power of magnetron, controlling the on/off states of nozzles, and compressor along with an on-board Wi-Fi module (not shown) for communicating with portable smart devices through an Apps and with a central computer through the internet.

4. The concept and embodiment as claimed in 1 to 3, wherein its membrane dryer type can be replaced with any other water-separator devices.

5. The concept and embodiment as claimed in 1 to 4, wherein its compressor can be replaced by any types of compressors depending on the level of pressure required for flying articles within the stationary drum space.

6. The concept and embodiment as claimed in 1 to 5, wherein its stationary drum, grid, and hot air nozzles can have different shapes and arrangements (front loading or top loading) depending on the size and type of application.

7. The concept and embodiment as claimed in 1 to 6, wherein its high-pressure tank can be separate containers with a separate heat exchanging system instead of a three-layer tank with three containers as aforementioned.

8. The concept and embodiment as claimed in 1 to 7, wherein its embodiment can be integrated in a washing machine to construct an integrated washer and dryer machine.

9. The concept and embodiment as claimed in 1 to 8, wherein its on-board Wi-Fi module sends all usage, settings, and consumption data to a central computer through internet.

10. The concept and embodiment as claimed in 1 to 9, wherein its application on portable smart devices can adjust the settings and display the system efficiency and the amount of water saved live to raise the awareness of sustainability.

11. The concept and embodiment as claimed in 1 to 10, wherein its stationary drum can have a special conveyor with hanging articles for commercial applications.

12. The concept and embodiment as claimed in 1 to 11, wherein its stationary drum with a special conveyor can form a continuous drying system.

13. The concept and embodiment as claimed in 1 to 12, which is scalable to any capacity for commercial applications.
